(19) United States
(12) Patent Application Publication
(10) Pub. No.: US 2011/0043869 A1
(43) Pub. Date: Feb. 24, 2011

(54) INFORMATION PROCESSING SYSTEM, ITS METHOD AND PROGRAM

(75) Inventor: Sumitaka Okajo, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku Tokyo (JP)

(21) Appl. No.: 12/809,256

(22) PCT Filed: Dec. 16, 2008
(86) PCT No.: PCT/JP2008/072824

§ 371 Date: Jun. 18, 2010

(30) Foreign Application Priority Data
Dec. 21, 2007 (JP) 2007 329475

(51) Int. Cl. H04N 1/04; G06F 17/30; G06K 9/00

(52) U.S. Cl. 358/474; 707/728; 707/E17.014; 382/168

(57) ABSTRACT

It is an object to provide an information processing system characterized in comprising an object classification means that classifies a document-composing object extracted from an electronic document or a document image into a text region-composing object and a chart region-composing object by using at least an area histogram of the object including a text.

### APPLICABLE FIELD IN THE INDUSTRY

The present invention relates to an information processing system, its method, and a program, and more particularly to a technology of analyzing an layout of an document image that is capable of region-segmenting a document in which charts, characters, etc. coexist by identifying/classifying a region of characters, and regions (chart region) other than characters, for example, a figure region and a table region.

### BACKGROUND ART

In recent years, a large volume of electronic documents in which texts and charts coexist are prepared by using software for preparing presentation. Further, a scheme of incorporating a paper document into a computer as a document image by employing an optical apparatus such as a scanner becomes active. Processing these electronic document and document image demands that the document should be partitioned into the text region and the chart region to subject the text region to processes for the text region such as an automatic summarization process, and to subject the chart region to processes for the chart region such as a process of extracting a color distribution and a statics process of numerical figures. Further, retrieving the document demands that the document previously prepared by itself, and the document formerly seen, which was prepared by a third person, should be retrieved based upon not a keyword, but rough remembrance of an arrangement etc. of the texts and the charts. This arouses a necessity for a process of partitioning the electronic document and the document image into the text region and the chart region, namely, a necessity for region-segmenting the electronic document and the document image.

One example of the system for analyzing a layout of the related document image is described in Patent document 1. This system for analyzing a layout of the related document image is configured of a basic line extraction means and a line/column reciprocal extraction means.

The system for analyzing a layout of the related document image, which has such a configuration, operates as described below.

That is, the system for analyzing a layout of the related document image has, as an input, an aggregation of the basic elements forming the document such as connected components of black pixels in the document image, overlapping rectangles enclosing connected components of black pixel in the document image, etc., wherein the basic line extraction means firstly generates a line by integrating the basic elements based upon an adjacency of the basic elements (a state in which character component partners are relatively closely arranged) and a similarity of the basic elements (a state in which character components are approximately equal to each other in size), and next, the line/column reciprocal extraction means integrates an aggregation of the lines to obtain the column based upon these adjacency and the similarity.

Further, another example of the system for analyzing a layout of the related document image is described in Patent document 2.

This system for analyzing a layout of the related document image is configured of a region extraction unit, an image generation unit, a feature calculation unit, and a distance calculation unit.

The system for analyzing a layout of the related document image, which has such a configuration, operates as described below.

That is, the region extraction unit analyzes the document image, and extracts a text region, a chart region, and a background region, the image generation unit generates the image from the document in which the extracted background region is painted out with the designated color for background, the text region is painted out with the designated color for text, and the chart region is painted out with the designated color for chart, the feature calculation unit calculates a layout feature indicative of a ratio of the background region over the generated image, a ratio of the text region, and a ratio of the chart region, a text feature indicative of a ratio of hiragana characters and katakana characters over the text region, a ratio of kanji characters, and a ratio of alphabets and numerical figures, and an image feature indicative of a ratio of an R component, a G component, and a B component over the color of the chart region, and the distance calculation unit calculates a distance, being a similarity of the layout feature between the document image having an layout that becomes a query of the retrieval and the retrieval-target document image, a distance, being a similarity of the text feature, and a distance, being a similarity of the image feature, and outputs the document images in an descending order of the distance.

Patent document 1: JP-P1999-219407A (pages 6 to 9, and FIG. 1 and FIG. 9)

Patent document 2: JP-P2006-318219A (pages 4 and 5, and FIG. 1)

### DISCLOSURE OF THE INVENTION

### Problems to be Solved by the Invention

A first problematic point resides in that any related art cannot cope with the document in which various character sizes are used for description within one document, and the document having a complicated layout. The reason is that the layout of the document for presentation or the like is complicated and yet multifarious, the line and the column cannot be extracted well when the text block partners are intricately arranged, or when the text block and the figure are intricately arranged, and the text region is over-integrated and over-segmented.

A second problematic point resides in that the similar document retrieval based upon an arrangement of the text regions and the image regions cannot be performed. The reason is that the similar document is retrieved by operating the distance calculation for a feature indicative of a ratio of the text region and the image region over the document image.

Thereupon, the present invention has been accomplished in consideration of the above-mentioned problems, and an object thereof is to provide an information processing system capable of region-segmenting not only the document in which various character sizes are used for description within one document, but also the document having a complicated layout, as is the case with the document for presentation, into the text regions and the chart regions which are equivalent to a one-lump portion in the eyes of human being, its method and a program.

### Means to Solve the Problem

The present invention for solving the above-mentioned problems is an information processing system characterized in including an object classification means for classifying objects forming the document extracted from the electronic document or the document image into objects forming the text region and objects forming the chart region by employing at least an area histogram of the object including the text.

The present invention for solving the above-mentioned problems is an information processing method characterized in including an object classification process of classifying objects forming the document extracted from the electronic document or the document image into objects forming the text region and objects forming the chart region by employing at least an area histogram of the object including the text.

The present invention for solving the above-mentioned problems is a program characterized in causing an information processing apparatus to execute an object classification process of classifying objects forming the document extracted from the electronic document or the document image into objects forming the text region and objects forming the chart region by employing at least an area histogram of an object including the text.

### AN ADVANTAGEOUS EFFECT OF THE INVENTION

In accordance with the present invention, the advantageous effect resides in that the document as well having a complicated and yet multifarious layout, for example, the document for presentation can be appropriately region-segmented into the text region and the chart region.

### BRIEF DESCRIPTION OF THE DRAWINGS

FIG. 1 is a block diagram illustrating a configuration of a first embodiment.

FIG. 2 is a flowchart illustrating an operation of the embodiment of the first invention.

FIG. 3 is a flowchart illustrating details of an operation (a step A2 of FIG. 2) of the object classification means of the first embodiment.

FIG. 4 is a view illustrating one example of the object classification employing the area histogram of the object.

FIG. 5 is a view illustrating another example of the object classification employing the area histogram of the object.

FIG. 6 is a flowchart illustrating details of an operation (a step A3 of FIG. 2) of a text region generation means and a chart region generation means of the first embodiment.

FIG. 7 is a view illustrating one example of the process of integrating the objects overlapping each other.

FIG. 8 is a view for explaining a visual impression distance.

FIG. 9 is a view illustrating an operation of the process of integrating the objects employing the visual impression distance.

FIG. 10 is a view illustrating a specific example of the process of integrating the objects employing the visual impression distance.

FIG. 11 is a view for explaining the visual impression distance.

FIG. 12 is a view for explaining the visual impression distance.

FIG. 13 is a view illustrating one example of region information.

FIG. 14 is a block diagram illustrating a configuration of a second embodiment.

FIG. 15 is a flowchart illustrating an operation of the second embodiment.

FIG. 16 is a view illustrating one example of a query input screen associated with a layout of the region.

FIG. 17 is a view illustrating a specific example of the process of integrating the regions inputted as a query, which employs the visual impression distance.

FIG. 18 is a view illustrating one example of the equation of calculating a region similarity.

FIG. 19 is a schematic view illustrating a correspondence of the region inputted as a query and the segmented region of the document.

FIG. 20 is a view illustrating one example of the equation of calculating an entire similarity, which employs an average value of the region similarities.

FIG. 21 is a view illustrating one example of the query input screen with a layout of the region and a keyword combined.

### DESCRIPTION OF NUMERALS

100 computer (central processing apparatus; processor; data processing apparatus)
110 object extraction means
120 object classification means
130 text region generation means
140 chart region generation means
150 region information generation means
160 region information storage means
170 region information conversion means
180 similarity calculation means
200 query input screen
210 region selector
220 layout input unit
230 retrieval button
240 (layout) clear button
250 layout clear button
260 keyword input unit
270 keyword clear button

### BEST MODE FOR CARRYING OUT THE INVENTION

### First Embodiment

The embodiments of the present invention will be explained in details with a reference to the accompanied drawings.

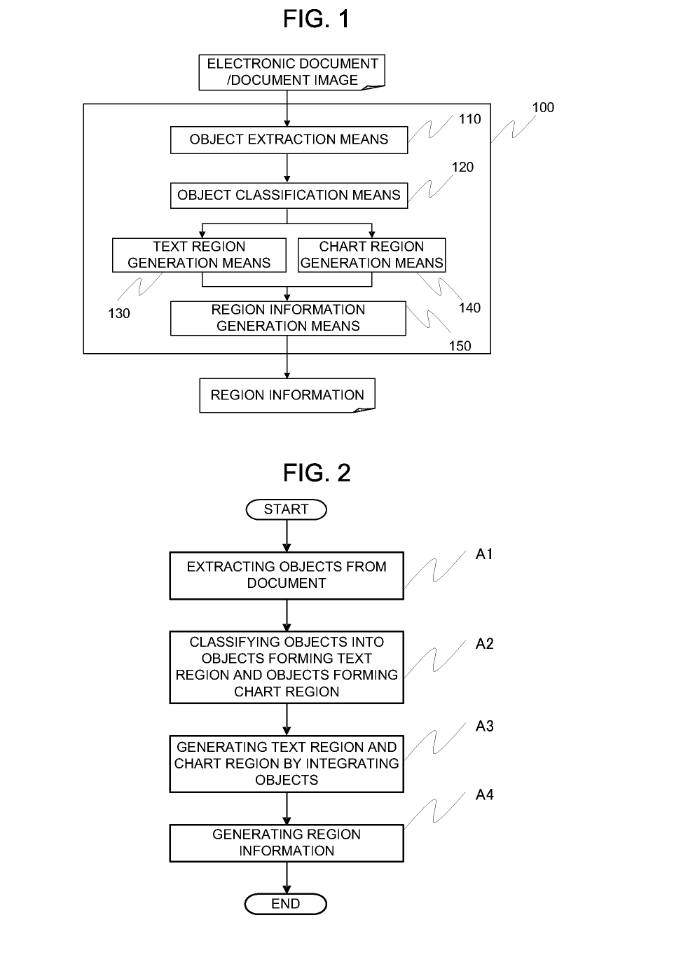

Upon making a reference to FIG. 1, an information processing system 100 in the first embodiment of the present invention is configured of an object extraction means 110, an object classification means 120, a text region generation means 130, a chart region generation means 140, and a region information generation means 150.

An outline of an operation of each of these means is described below.

The object extraction means 110 analyzes the electronic document or the document image, and extracts objects that are included in the document. Herein, the so-called object represents a character, a line, a text block comprised of a plurality of the characters or the lines, a figure, a table, a graph, and an image. As the related art associated with extraction of the object from the document image, there exist a threshold process, a labeling process, an edge process, and the like, and the present invention also extracts the object from the document image by employing these related arts. Further, as far as the electronic document prepared with software for preparing presentation concerned (for example, PowerPoint (registered trademark) of Microsoft Corporation (registered trademark), the present invention analyzes its data file, and extracts the objects. This embodiment will be explained with the latter case exemplified.

The object classification means 120 classifies the objects extracted by the object extraction means 110 into the objects forming the text region and the objects forming the chart region based upon the area histogram of the object including the text.

The text region generation means 130 performs a process of integrating the objects classified as an object forming the text region by the object classification means 120 based upon the visual impression distance, and generates the text region that is configured of a plurality of the objects.

The chart region generation means 140 performs a process of integrating the objects classified as an object forming the chart region by the object classification means 120 based upon the visual impression distance, and generates the chart region that is configured of a plurality of the objects.

The region information generation means 150 generates the region information expressive of respective regions generated by the text region generation means 130 and the chart region generation means 140.

Next, an entire operation of this embodiment will be explained in details with a reference to FIG. 1 and a flowchart of FIG. 2.

The electronic document given by an input apparatus (not shown in the figure) is supplied to the object extraction means 110.

The object extraction means 110 extracts the objects such as the text block, the figure, the table, the graph, and the image, which are included in the document, by utilizing a function prepared by the presentation preparation software, analyzing the electronic document data file, or the like. At this time, the object extraction means 110 generates a minimum bounding rectangle (MBR) comprised of sides parallel to an x axis and a y axis, respectively, in terms of each of the objects extracted simultaneously (step A1 of FIG. 2).

Next, the object classification means 120 classifies the objects extracted by the object extraction means 110 into the objects forming the text region and the objects forming the chart region based upon the area histogram of the object including the text (step A2).

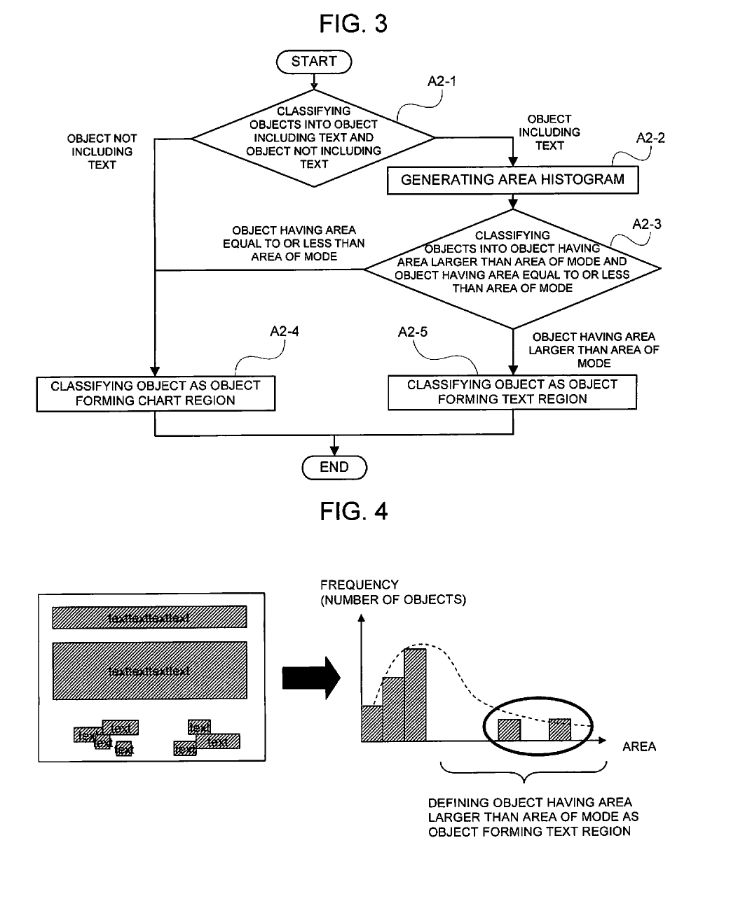

The technique of classifying the objects at this time will be explained by employing a flowchart of FIG. 3.

At first, the object classification means 120 classifies the objects into the object (text block) including the text and the object (the figure, the table, the graph, and the image) not including the text (step A2-1). Herein, the object not including the text is classified as an object forming the chart region. However, there is the case that the text block is the object forming the chart region, whereby, next, the object classification means 120 classifies the text block into the objects forming the text region and the objects forming the chart region. For this, the histogram of the object area by one page (namely, one sheet of slide of the presentation) is generated (step A2-2). The text block forming the text region is characterized in that the number of the objects to be included in one sheet of slide is small, yet the character within the block is large in size, and the number of the characters is large because the content, which is coherent to a certain degree, is described within one block with a natural sentence. Contrary hereto, the text block forming the chart region is characterized in that the number of the objects to be included in one sheet of slide is large, yet the character within the block is small in size, and the number of the characters is small because one word or one clause is used for description within one block.

Therefore, the text block forming the text region is large in the area and yet a frequency of appearance thereof is small, and the text block forming the chart region is small in the area and yet a frequency of appearance thereof is large. Thereupon, as shown in FIG. 4, the area of the MBR of each text block is obtained to generate the area histogram, the object having an area larger than the area of a mode is classified as an object forming the text region, and the object having an area equal to or more than the area of a mode as an object forming the chart region (step A2-3). However, when all of the objects being included in one sheet of slide are objects including the text as a result of firstly classifying the objects into the object including the text and the object not including the text, all of these objects are classified as objects forming the text region. Additionally, while in the foregoing example, the object of which the area was equal to the area of the mode was classified as an object forming the chart region, the object forming the chart region is not limited hereto, and the object of which the area is equal to the area of the mode may be classified as an object forming the text region without departing from the sprit and scope of the invention.

Above, with the process of the step A2-1 to the step A2-3, the objects are classified into the objects forming the text region and the objects forming the chart region (steps A2-4 and A2-5).

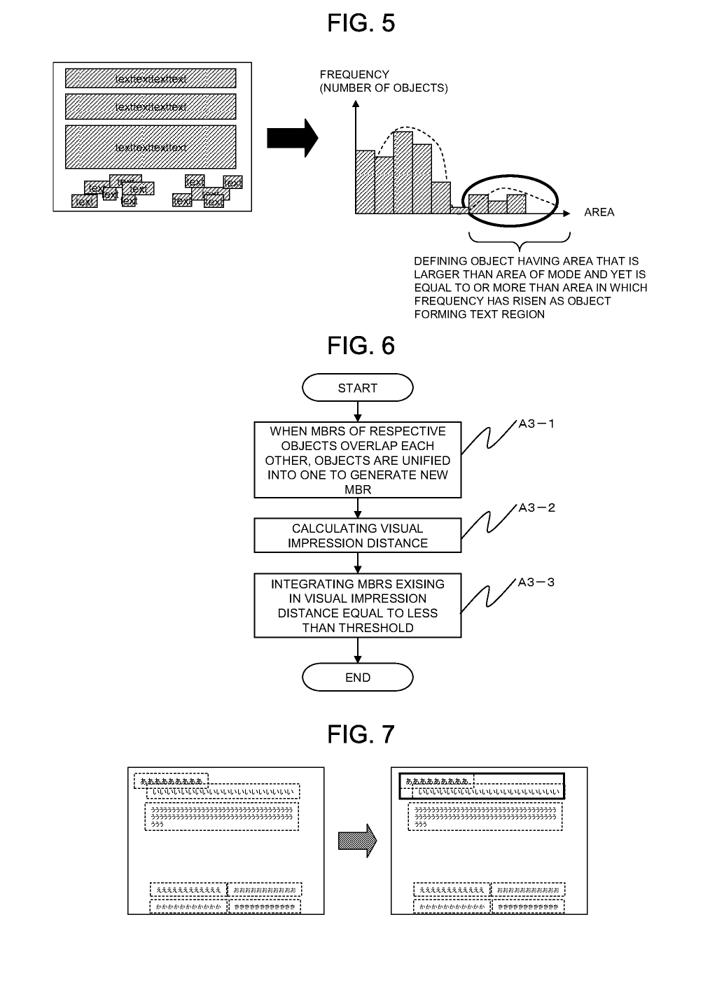

While, as a rule, there is a large difference between the area of the text block forming the text region and that of the text block forming the chart region; however, the case that such a difference does not exist is thinkable, whereby the object having an area that is larger than the area of the mode, and yet is equal to or more than the area in which the frequency has risen may be classified as an object forming the text region as described in FIG. 5 at the moment of classifying the text blocks by the area histogram.

Next, the objects classified by the object classification means 120 into two classes of the object forming the text region and the object forming the chart region are subjected to the integration process and are collected in order to generate the text region and the chart region, respectively (step A3).

In many cases, the text is described with the characters having various sizes, large and small, and a one-lump of the text groups each having the related content are described with the different text blocks in the presentation document etc. Further, the arrangement of the objects forming the chart region is also complicated. However, so as to keep readability to a certain degree, there exits the following features:

(1) The text block forming the text region is arranged with the rectangle as a basic shape.

(2) The objects, each of which has a high relativity with the other, are arranged closely to each other so that they become one cluster at a glance.

(3) These one-cluster portions of the object groups are spaciously arranged so that each of them is identifiable.

The process of integrating the objects, which takes these features into consideration, will be explained by employing a flowchart of FIG. 6.

At first, the text region generation means 130 integrates the object partners overlapping each other into one object in terms of the MBR of each object classified as an object forming the text region, and generates a new MBR (step A3-1).

An example of this integration process is shown in FIG. 7. In FIG. 7, two objects overlapping each other in the upper portion of the document are integrated into one object. Next, the objects existing visually closely to each other, out of the objects not overlapping each other, can be thought to be objects each having a content relating to the content the other, whereby these objects existing visually closely to each other need to be furthermore integrated. For this, the present invention calculates a distance (hereinafter, referred to as a visual impression distance) between the objects that takes human being's visual impression into consideration (step A3-2).

Next, with the objects existing in one page, the visual impression distance is calculated for all of the combinations of two objects, and the object partners of which a value of the distance is equal to or less than a threshold are integrated to generate the text region (step A3-3).

The calculation of this visual impression distance and the integration of the object partners will be explained with a reference to the accompanied drawings.

The visual impression distance is calculated in such a manner that the nearer the distance between the sides of the MBRs of two objects facing each other, and the larger the length of the overlap obtained at the time of projecting these two sides onto the axis parallel to the sides, more “closely” the two objects are located.

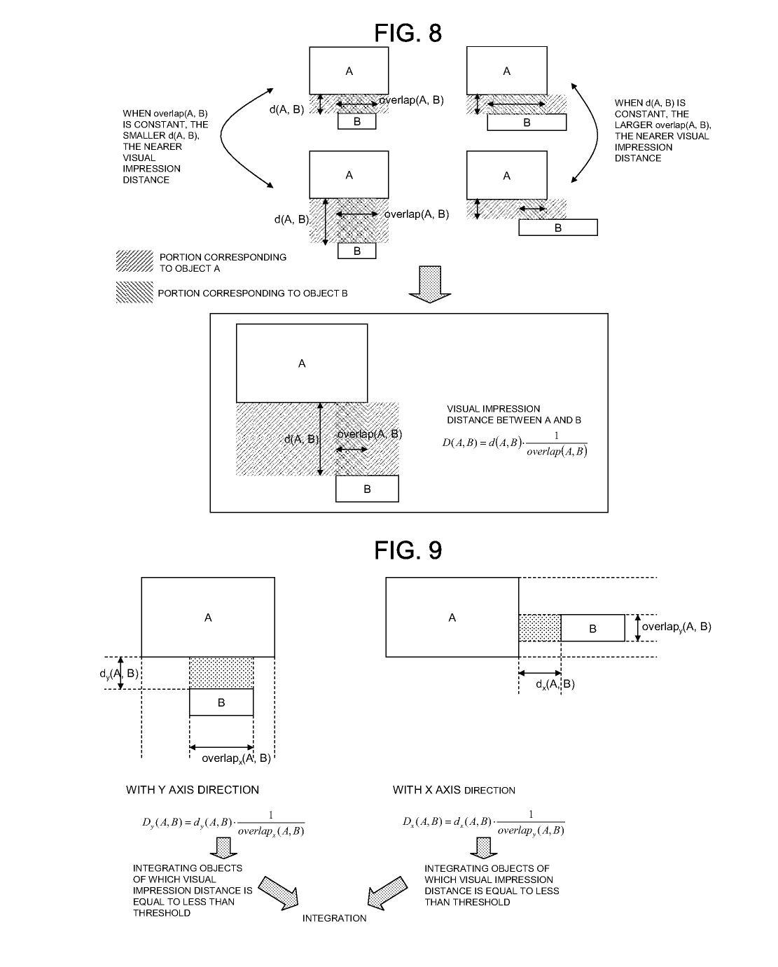

FIG. 8 shows one example of calculating a visual impression distance D (A, B) between the MBR of an object A and the MBR of an object B. In FIG. 8, when the length (=overlap(A, B)) of the overlap obtained at the time of projecting two sides of the MRBs of two objects facing each other onto the axis parallel to the sides is a constant, the nearer a distance (=d(A, B)) between the sides facing each other of the MBRs of two objects, the nearer the visual impression distance between two objects becomes. Further, when the distance (=d(A, B)) between the sides facing each other of the MBRs of two objects is identical, the larger the length (=overlap(A, B)) of the overlap obtained at the time of projecting two sides of the MRBs of two objects facing each other onto the axis parallel to the sides, the nearer the visual impression distance between two objects becomes.

Thus, the visual impression distance D(A, B) between the object A and the object B becomes D(A, B)=d(A, B)×1/=overlap(A, B).

The distance calculation of the object is performed by employing this visual impression distance; however, at the time of projecting the sides of the MRBs of two objects facing each other, the case that the MBRs of two objects overlap each other in the x axis direction, and the case that the MBRs of two objects overlap each other in the y axis direction are thinkable, whereby, as a matter of fact, the visual impression distance between the objects overlapping each other in the x axis direction is calculated, and the objects of which the visual impression distance is equal to or less a threshold (the visual impression distance is near) are integrated as shown in FIG. 9. Likewise, the visual impression distance between the objects overlapping each other in the y axis direction is calculated, and the objects of which the visual impression distance is equal to or less a threshold (the visual impression distance is near) are integrated. And, the objects integrated in the x axis direction and in the y axis direction are finally integrated.

An example of the integration process with the visual impression distance is shown in FIG. 10. It is assumed in the example of FIG. 10 that six MBRs have been generated as a result of integrating the objects overlapping each other in the step A3-1. When the visual impression distance is calculated for these six MBRs in the x axis direction and in the y axis direction, separately, to integrate the MBRs of which the distance is equal to or less the threshold, MBR 3 and MBR 5, and MBR 4 and MBR 5 are integrated, respectively, in the x axis direction, and MBR 1 and MBR 2, and MBR 3 and MBR 4 are integrated, respectively, in the y axis direction. In addition, MBR 1 and MBR 2 are integrated, and MBR 3, MBR 4 and MBR 5 are integrated finally by piling up respective integration results in the x axis direction and in the y axis direction.

As a threshold at the moment of integrating the MBRs with the visual impression distance, for example, an average value of the distances of all of the combinations of the arbitrary two MBRs, which are included in one sheet of slide, and so on may be employed. Further, the fixed value may be given in advance.

With the process mentioned above, the text region is generated.

Next, the chart region generation means 140, similarly to the text region generation means 130, performs the process shown in the flowchart of FIG. 6 for the MBR of each object classified as an object forming the chart region. With this, the chart region is generated.

Additionally, while after the text region generation means 130 generated the text region, the chart region generation means 140 generated the chart region in the above explanation, after the chart region generation means 140 generates the chart region, the text region generation means 130 may generate the text region.

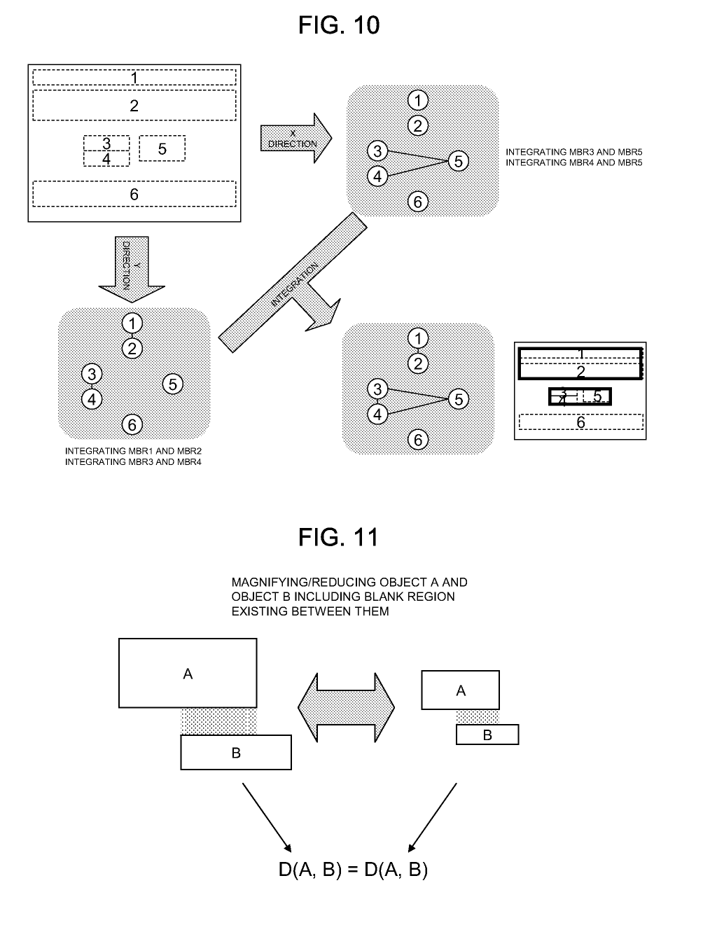

In accordance with the equation of calculating the visual impression distance of this embodiment, it is possible to calculate the distance not as an absolute distance between the objects, but as a relative distance at the moment of calculating the distance that is employed in the process of integrating the objects, and to calculate the identical value even when magnifying/reducing a plurality of the objects (see FIG. 11). This makes it possible to calculate the distance responding to a ratio of the area between the object and the blank region without using absolute dimensions of the object and the blank region existing between them, and to determine whether the distance is near or far.

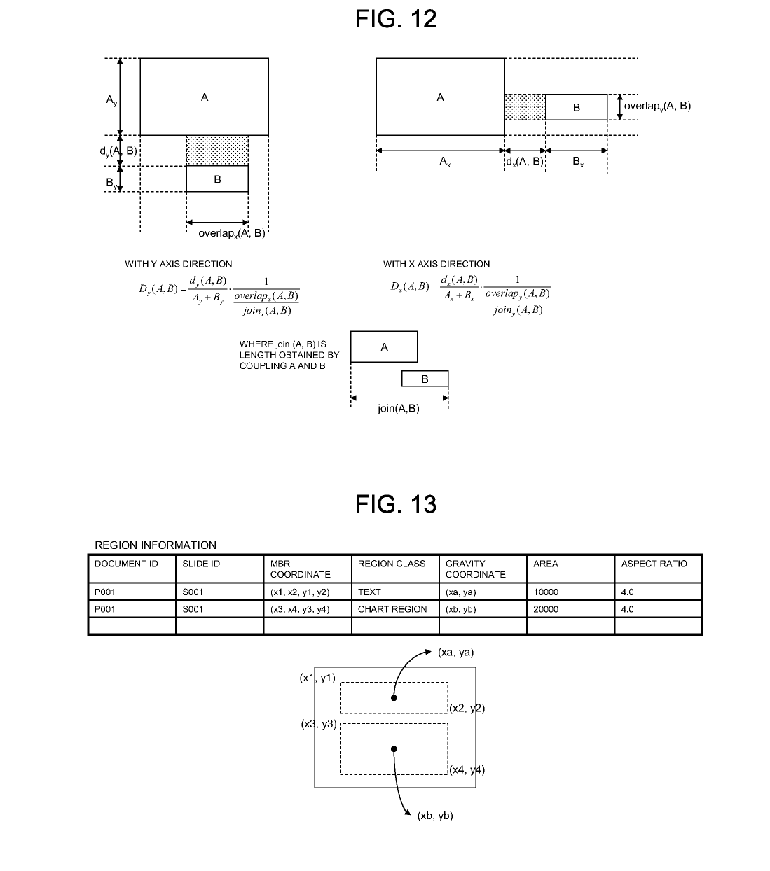

Further, the visual impression distance may be defined as shown in FIG. 12.

In accordance with FIG. 12, when it is assumed that the length in the y axis direction of the MBR of the object A, the length in the y axis direction of the MBR of the object B, the distance in the y axis direction between the sides of the MBRs of two objects facing each other, the distance obtained at the time of projecting two sides of the MBR of the object A and the MBR of the object B onto the x axis parallel to the sides, and the length of the overlap obtained at the time of projecting two sides of the MBR of the object A and the MBR of the object B onto the x axis parallel to the sides are A_{y}, B_{y}, d_{y}(A, B), joinₓ(A, B), and overlapₓ(A, B), respectively, a visual impression distance D_{y}(A, B) in the y axis direction becomes the following equation.

D_{y}(A,B)=d_{y}(A,B)/(A_{y}+B_{y})×1/overlapₓ(A,B)/joinₓ(A,B)=(d_{y}(A,B)×joinₓ(A,B))/((A_{y}+B_{y})×overlapₓ(A,B))

Likewise, when it is assumed that the length in the x axis direction of the MBR of the object A, the length in the x axis direction of the MBR of the object B, the distance in the x axis direction between the sides of the MBRs of two objects facing each other, the length obtained at the time of projecting two sides of the MBR of the object A and the MBR of the object B onto the y axis parallel to the sides, and the length of the overlap obtained at the time of projecting two sides of the MBR of the object A and the MBR of the object B onto the y axis parallel to the sides, are Aₓ, Bₓ, dₓ(A, B), join_{y}(A, B), and overlap_{y}(A, B), respectively, a visual impression distance Dₓ(A, B) in the x axis direction becomes the following equation.

Dₓ(A,B)=dₓ(A,B)/(Aₓ+Bₓ)×1/overlap_{y}(A,B)/join_{y}(A,B)=(dₓ(A,B)×join_{y}(A,B))/((Aₓ+Bₓ)×overlap_{y}(A,B))

In this case, the calculation is performed in such a manner that two objects of which the object area is larger as against the distance, and yet of which a ratio of the overlapping portion is larger are more closely located.

Finally, from the text region and the chart region generated by the text region generation means 130 and the chart region generation means 140, respectively, the region information generation means 150 generates region information expressive of these regions (step A4). An example of the region information is shown in FIG. 13. In this example, the region information is comprised of a document ID, a slide ID, and an MBR coordinate, a region class, a gravity coordinate, an area and a aspect ratio of each region.

This embodiment is configured so that the objects each of which becomes a configuration element of the document are classified into the objects forming the text region and the objects forming the chart region at the moment of region-segmenting the electronic document or the document image, and then the objects are integrated, whereby the document can be appropriately segmented into the text region and the chart region. This makes it possible to precisely and efficiently perform the processes responding to the region, namely, to extract only the text region from the document, or to extract only the chart region, and in addition, for example, to perform a character recognition process only for the text region.

### Second Embodiment

The best mode for carrying out the second invention of the present invention will be explained in details with a reference to the accompanied drawings.

The second embodiment provides an information processing system capable of retrieving the similar document based upon an arrangement of the text regions and the image regions, its method, a program.

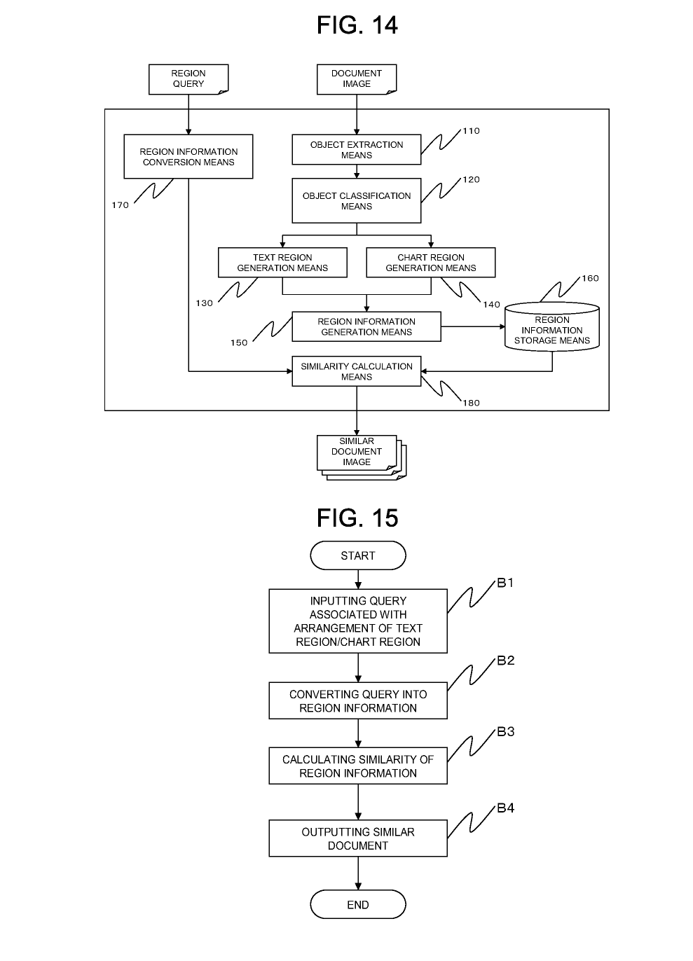

Upon making a reference to FIG. 14, the best mode for carrying out the second invention of the present invention operates under control of a program.

An information processing system 100 includes an object extraction means 110, an object classification means 120, a text region generation means 130, a chart region generation means 140, a region information generation means 150, a region information storage means 160, a region information conversion means 170, and a similarity calculation means 180.

Herein, each of the object extraction means 110, the object classification means 120, the text region generation means 130, the chart region generation means 140, and the region information generation means 150 has a configuration similar to the configuration of the first embodiment shown in FIG. 1, so its explanation is omitted.

The region information storage means 160 stores the region information of the electronic document and the document image that is outputted from the region information generation means 150.

The region information conversion means 170 converts a retrieval query associated with a position and a size of the text region and the chart region of the document into region information. Herein, the so-called query is an item inputted by a user in order to retrieve the document.

The similarity calculation means 180 compares/collates the region information stored by the region information storage means 160 with the region information to be outputted by the region information conversion means 170, calculates the similarity, and retrieves the similar document.

Next, an entire operation of this embodiment will be explained in details with a reference to flowcharts of FIG. 14 and FIG. 15.

First, the electronic document and the document image are region-segmented in advance according to the flowchart shown in FIG. 2, and its region information is stored into the region information storage means 160.

Next, a user inputs a position and a size of the text region and the chart region of the document as an layout of the document by employing an input means (not shown in the figure) such as a keyboard and a mouse connected to a computer 100 (step B1). FIG. 16 shows one example of a query input screen 200 of the layout of the slide to be included in a certain document. The user inputs the layout of the slide by employing the input means such as the keyboard and the mouse via the screen to be displayed on an output means (not shown in the figure) such as a display connected to the computer 100.

At first, the user selects any of the text region and the chart region in a region selector 210. Next, when the user designates the rectangle by mouse dragging etc. in a layout input unit 220, the rectangular region responding to the class of the region selected by the region selector 210 is depicted. Further, the user may select the depicted rectangle with the mouse etc. to migrate a position of the rectangle in some case, to change a shape in some cases, and to magnify/reduce the size in some case. In an example of FIG. 16, the text region is designated in an upper part of the slide, and the chart region is designated in a lower part of the slide. Finally, when a retrieval button 230 is pushed down, the document retrieval based upon the layout designated by the layout input unit 220 is initiated. When a clear button 240 is pushed down, the rectangle depicted in the layout input unit 220 is deleted, and the input of the layout can be tried again.

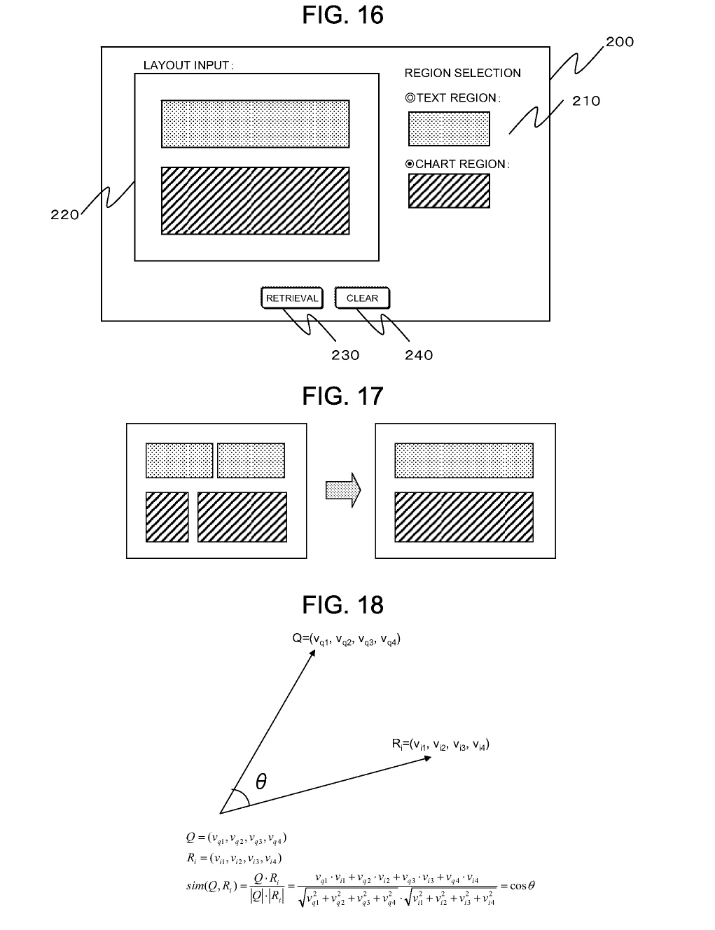

When the above-mentioned retrieval button 230 is pushed down, the region information conversion means 170 firstly converts the retrieval query associated with a position and a size of the text region and the chart region designated by the layout input unit 220 into region information similar to the region information generated by the region information generation means 150 and stored by the region information storage means 160 (step B2). At this time, when a plurality of the designated regions each having an identical region class exist in the region designated by the user in the step B1, the region information conversion means 170 converts the region into the region information after performing the process of integrating the regions, which employs the visual impression distance shown in the steps A3-2 and A3-3 of the flowchart of FIG. 6. For example, in an example shown in FIG. 17, two text regions and two chart regions are integrated into one text region and one chart region, respectively, as a result of performing the process of integrating the regions that employs the visual impression distance. Further, a configuration may be made so that the user can select whether or not to perform the process of integrating the regions that employs the visual impression distance.

Next, the similarity calculation means 180 compares the region information converted by the region information conversion means 170 from the query associated with the layout inputted by the user with the by-document region information stored in the region information storage means 160, thereby to calculate a similarity between the layout of the region inputted by the user and the layout of the region of the segmented document (step B3).

As the similarity, for example, an average value of the region similarities, being similarities of individual responding regions, is employed. As the equation of calculating the region similarity, for example, a cosine measure with an angle θ subtended by feature vectors to be obtained from the region information is employed for the region having an identical region class (the text region or the coordinate region). Now, when the feature vector, which is obtained from the region information shown in FIG. 13, is expressed with a four-dimensional vector of an x coordinate v1 of a gravity, an y coordinate v2 of a gravity, an area v3, an aspect ratio v4, a similarity sim(Q, Ri) employing the cosine measure of a feature vector Q of the region converted from the query inputted by the user and a feature vector Ri of the region stored in the region information storage means 160 can be obtained as shown in FIG. 18.

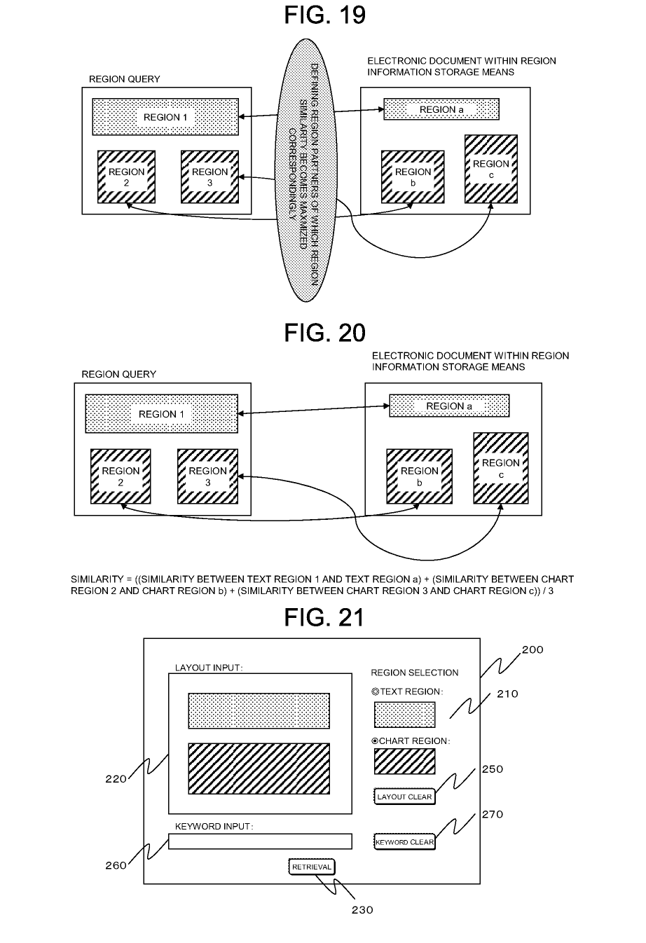

The similarity calculation means 180 calculates the region similarity in terms of all of the combinations of respective regions to be included in the region information converted from the query, and the regions to be included in the by-document region information, correspondingly defines the region having a maximum similarity as a region corresponding to the region converted from the query as shown in FIG. 19, and regards the above value as a region similarity between these two regions. Finally, the similarity calculation means 180 obtains an average value of the similarities of respective regions correspondingly defined as shown in FIG. 20, and regards it as a similarity between the region layout inputted by the user and the region layout of the document. Additionally, the similarity of an example shown in FIG. 20 behaves like the following.

Similarity=((similarity between text region 1 and text region a)+(similarity between chart region 2 and chart region b)+(similarity between chart region 3 and chart region c))/3

Finally, the similarity calculation means 180 identifies the slide having a region layout resembling the region layout inputted by the user with the step B3, sorts out the slides in a descending order of the similarity, and presents them to the user (step B4).

Further, the user may simultaneously designate the keyword in the conventional keyword retrieval in addition to inputting the layout of the document as a query.

FIG. 21 shows one example of the query input screen 200 for designating the layout of the document and the keyword as a retrieval query. The user inputs the layout, similarly to the above-mentioned case, and further, designates the keyword to be included in the slide in the keyword input unit 260. When the retrieval button 230 is pushed down, the document retrieval based upon the layout designated by the layout input unit 220 and the keyword designated by the keyword input unit 260 is initiated. At this time, it is assumed that utilizing the related art associated with the keyword retrieval enables the slide in which the designated keyword is included to be retrieved. The retrieval process with a combination of the layout and the keyword operates so as to calculate the similarity of the layout explained above only for the slide retrieved with the keyword. This makes it possible to retrieve the slide resembling the designated layout only from the slides including the designated keyword. Further, when a layout clear button 250 and a keyword clear button 260 are pushed down, the rectangle depicted in the layout input unit 220, and the keyword inputted into the keyword input unit 260 are deleted, respectively, and the input of the region layout and the keyword can be tried once again.

Further, a configuration may be made so that, when the user inputs the layout of the region, the user itself, according to its confidence in memorization, makes a weighting as to which region, out of the text region and the chart region, is regarded as an important one, or as to which region, out of the inputted regions, is regarded as an important one.

The embodiment of the present invention is configured to compare/collate the region information generated by region-segmenting the electronic document and the document image in advance with the region information generated from the query associated with the layout of the region inputted by the user, and to retrieve the document having the similar layout, whereby the document can be retrieved based upon an arrangement of the text regions and the chart documents even when the user does not correctly remember the keyword to be included in the document. That is, the effect of the embodiment of the present invention resides in that the similar document can be retrieved based upon an arrangement of the text regions and the chart documents.

Further, the mode of the present invention is configured to designate the keyword, which is included in the document, together with the layout of the region, whereby the document can be retrieved based upon a combination of an arrangement of the text regions and the chart documents, and the keyword.

Additionally, while each configuration unit was configured with hardware in the foregoing first embodiment and second embodiment, it can be also realized with a computer that is configured of CPU and a memory.

The 1st mode of the present invention is characterized in that an information processing system, comprising an object classification means for classifying objects forming a document extracted from an electronic document or a document image into objects forming a text region and objects forming a chart region by employing at least an area histogram of the object including a text.

The 2nd mode of the present invention, in the above-mentioned mode, is characterized in that said object classification means calculates the area histogram of the object including the text, and classifies said objects including the text into the objects forming the text region and the objects forming the chart region responding to a comparison with the area that becomes a mode.

The 3rd mode of the present invention, in the above-mentioned mode, is characterized in that said object classification means is configured to calculate the area histogram of the object including the text, to classify the object having an area larger than the area that becomes a mode as an object forming the text region, and to classify the object having an area smaller than the mode and the object not including the text as an object forming the chart region, respectively.

The 4th mode of the present invention, in the above-mentioned mode, is characterized in that said object classification means is configured to calculate the area histogram of the objects including the text, to classify the object having an area that is larger than the area that becomes a mode and yet is larger than the area in which a frequency has re-risen as an object forming the text region, and to classify the object not classified as an object forming the text region, out of said objects including the text, and the object not including the text as an object forming the chart region, respectively.

The 5th mode of the present invention, in the above-mentioned mode, is characterized in that the information processing system comprising an object extraction means for extracting the objects forming the document from the electronic document or the document image.

The 6th mode of the present invention, in the above-mentioned mode, is characterized in that the information processing system comprising: a text region generation means for integrating the objects forming the text region based upon a visual impression distance, being a distance between the objects taking human being's visual impression into consideration, and generating the text region; a chart region generation means for integrating the objects forming the chart region based upon said visual impression distance, and generating the chart region; and a region information generation means for generating and outputting information expressive of the text region and the chart region.

The 7th mode of the present invention, in the above-mentioned mode, is characterized in that said text region generation means or said chart region generation means is configured to integrate the objects and to generate the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as Dl in terms of the objects having an overlap at the time of projecting two objects to the x axis or the y axis, and a length of an overlapping portion at the time of projecting the sides facing each other to the axis parallel to these sides is defined as D2, calculating D1/D2 as the visual impression distance, determining whether or not to integrate these two objects responding to a comparison between a value of the visual impression distance D1/D2 and a threshold, and performing a process of integrating said two objects in terms of the x axis direction and the y axis direction, respectively, in a case of integrating the objects.

The 8th mode of the present invention, in the above-mentioned mode, is characterized in that said text region generation means or said chart region generation means is configured to integrate the objects and to generate the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis and the y axis, a length of an overlapping portion at the time of projecting the sides facing each other to the axis parallel to these sides is defined as D2, a sum of lengths of sides perpendicular to the sides facing each other of two objects is defined as D3, and an entire length at the time of projecting the sides facing each other to the axis parallel to these sides is defined as D4, determining whether or not to integrate these two objects responding to a comparison between a value of (D1×D4)/(D2×D3) and a threshold, and performing a process of integrating said two objects in terms of the x axis direction and the y axis direction, respectively, in a case of integrating the objects.

The 9th mode of the present invention, in the above-mentioned mode, is characterized in that said text region generation means or said chart region generation means is configured to calculate the visual impression distance in terms of all of combinations of the minimum bounding rectangles of arbitrary two objects being included in one sheet of slide, and to define an average value thereof as said threshold.

The 10th mode of the present invention, in the above-mentioned mode, is characterized in that the information processing system further comprising: a region information storage means for storing the region information of the electronic document and the document image; a region information conversion means for converting a query associated with a layout of the region of the electronic document and the document image into the region information, said query inputted by a user; and a similarity calculation means for comparing the region information stored by said region information storage means with the region information converted by said region information conversion means, and calculating a similarity, wherein the document having a layout resembling the layout of the document inputted by the user is retrieved.

The 11th mode of the present invention, in the above-mentioned mode, is characterized in that said similarity calculation means is configured to calculate the similarity by comparing a gravity coordinate value expressive of a position of the region, an area expressive of a size of the region, and an aspect ratio expressive of a shape of the region for each region class of the text region and the chart region.

The 12th mode of the present invention, in the above-mentioned mode, is characterized in that said similarity calculation means employs a cosine value of an angle subtended by feature vectors of two regions comprised of an x coordinate of the gravity, a y coordinate of the gravity, the area, and the aspect ratio when calculating the similarity.

The 13th mode of the present invention, in the above-mentioned mode, is characterized in that the information processing system further comprising a keyword retrieval means for retrieving the document including an inputted keyword: wherein said similarity calculation means calculates the similarity only for the document retrieved by said keyword retrieval means; and wherein the document including the keyword inputted by the user and yet having a layout resembling the layout of the document inputted by the user is retrieved.

The 14th mode of the present invention, in the above-mentioned mode, is characterized in that an information processing method, comprising an object classification process of classifying objects forming a document extracted from an electronic document or a document image into objects forming a text region and objects forming a chart region by employing at least an area histogram of the object including a text.

The 15th mode of the present invention, in the above-mentioned mode, is characterized in that said object classification process calculates the area histogram of the object including the text, and classifies said objects including the text into the objects forming the text region and the objects forming the chart region responding to a comparison with the area that becomes a mode.

The 16th mode of the present invention, in the above-mentioned mode, is characterized in that said object classification process calculates the area histogram of the object including the text, classifies the object having an area larger than the area that becomes a mode as an object forming the text region, and classifies the object having an area smaller than the mode and the object not including the text into as an object forming the chart region, respectively.

The 17th mode of the present invention, in the above-mentioned mode, is characterized in that said object classification process calculates the area histogram of the object including the text, classifies the object having an area that is larger than the area that becomes a mode, and yet is larger than the area in which a frequency has re-risen as an object forming the text region, and classifies the object not classified as an object forming the text region, out of said objects including the text, and the object not including the text as an object forming the chart region, respectively.

The 18th mode of the present invention, in the above-mentioned mode, is characterized in that the information processing method comprising an object extraction process of extracting the objects forming the document from the electronic document or the document image.

The 19th mode of the present invention, in the above-mentioned mode, is characterized in that the information processing method comprising: a text region generation process of integrating the objects forming the text region based upon a visual impression distance, being a distance between the objects taking human being's visual impression into consideration, and generating the text region; a chart region generation process of integrating the objects forming the chart region based upon said visual impression distance, and generating the chart region; and a region information generation process of generating and outputting information expressive of the text region and the chart region.

The 20th mode of the present invention, in the above-mentioned mode, is characterized in that said text region generation process or said chart region generation process integrates the objects and generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis or the y axis, and a length of an overlapping portion at the time of projecting the sides facing each other to the axis parallel to these sides is defined as D2, calculating D1/D2 as the visual impression distance, determining whether or not to integrate these two objects responding to a comparison between a value of the visual impression distance D1/D2 and a threshold, and performing a process of integrating said two objects in terms of the x axis direction and the y axis direction, respectively, in a case of integrating the objects.

The 21st mode of the present invention, in the above-mentioned mode, is characterized in that said text region generation process or said chart region generation process integrates the objects and generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis or the y axis, a length of an overlapping portion at the time of projecting the sides facing each other to the axis parallel to these sides is defined as D2, a sum of lengths of sides perpendicular to the sides facing each other of two objects is defined as D3, and an entire length at the time of projecting the sides facing each other to the axis parallel to these sides is defined as D4, determining whether or not to integrate these two objects responding to a comparison between a value of (D1×D4)/(D2×D3) and a threshold, and performing a process of integrating said two objects in terms of the x axis direction and the y axis direction, respectively, in a case of integrating the objects.

The 22nd mode of the present invention, in the above-mentioned mode, is characterized in that said text region generation process or said chart region generation process calculates the visual impression distance in terms of all of combinations of the minimum bounding rectangles of arbitrary two objects being included in one sheet of slide, and defines an average value thereof as said threshold.

The 23rd mode of the present invention, in the above-mentioned mode, is characterized in that the information processing method further comprising: a region information conversion process of converting a query associated with a layout of the region of the electronic document and the document image into the region information, said query inputted by a user; and a similarity calculation process of comparing the region information of the electronic document and the document image with the region information converted by said region information conversion process, and calculating a similarity, wherein the document having a layout resembling the layout of the region of the document inputted by the user is retrieved.

The 24th mode of the present invention, in the above-mentioned mode, is characterized in that said similarity calculation process calculates the similarity by comparing a gravity coordinate value expressive of a position of the region, an area expressive of a size of the region, and an aspect ratio expressive of a shape of the region for each region class of the text region and the chart region.

The 25th mode of the present invention, in the above-mentioned mode, is characterized in that said similarity calculation process employs a cosine value of an angle subtended by feature vectors of two regions comprised of an x coordinate of the gravity, a y coordinate of the gravity, the area, and the aspect ratio when calculating the similarity.

The 26th mode of the present invention, in the above-mentioned mode, is characterized in that the information processing method further comprising a keyword retrieval process of retrieving the document including an inputted keyword: wherein said similarity calculation process calculates the similarity only for the document retrieved by said keyword retrieval process; and wherein the document including the keyword inputted by the user and yet having a layout resembling the layout of the region of the document inputted by the user is retrieved.

The 27th mode of the present invention, in the above-mentioned mode, is characterized in that a program for causing an information processing apparatus to execute an object classification process of classifying objects forming a document extracted from an electronic document or a document image into objects forming a text region and objects forming a chart region by employing at least an area histogram of the object including a text.

The 28th mode of the present invention, in the above-mentioned mode, is characterized in that said object classification process calculates the area histogram of the object including the text, and classifies said objects including the text into the objects forming the text region and the objects forming the chart region responding to a comparison with the area that becomes a mode.

The 29th mode of the present invention, in the above-mentioned mode, is characterized in that said object classification process calculates the area histogram of the object including the text, classifies the object having an area larger than the area that becomes a mode as an object forming the text region, and classifies the object having an area smaller than the mode and the object not including the text as an object forming the chart region, respectively.

The 30th mode of the present invention, in the above-mentioned mode, is characterized in that said object classification process calculates the area histogram of the object including the text, classifies the object having an area that is larger than the area that becomes a mode, and yet is larger than the area in which a frequency has re-risen as an object forming the text region, and classifies the object not classified as an object forming the text region, out of said objects including the text, and the object not including the text as an object forming the chart region, respectively.

The 31st mode of the present invention, in the above-mentioned mode, is characterized in that the program causing the information processing apparatus to execute an object extraction process of extracting the objects forming the document from the electronic document or the document image.

The 32nd mode of the present invention, in the above-mentioned mode, is characterized in that the program comprising: a text region generation process of integrating the objects forming the text region based upon a visual impression distance, being a distance between the objects taking human being's visual impression into consideration, and generating the text region; a chart region generation process of integrating the objects forming the chart region based upon said visual impression distance, and generating the chart region; and a region information generation process of generating and outputting information expressive of the text region and the chart region.

The 33rd mode of the present invention, in the above-mentioned mode, is characterized in that said text region generation process or said chart region generation process integrates the objects and generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis and the y axis, and a length of an overlapping portion at the time of projecting the sides facing each other to the axis parallel to these sides is defined as D2, calculating D1/D2 as the visual impression distance, determining whether or not to integrate these two objects responding to a comparison between a value of the visual impression distance D1/D2 and a threshold, and performing a process of integrating said two objects in terms of the x axis direction and the y axis direction, respectively, in a case of integrating the objects.

The 34th mode of the present invention, in the above-mentioned mode, is characterized in that said text region generation process or said chart region generation process integrates the objects and generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis and the y axis, a length of an overlapping portion at the time of projecting the sides facing each other to the axis parallel to these sides is defined as D2, a sum of lengths of sides perpendicular to the sides facing each other of two objects is defined as D3, and an entire length at the time of projecting the sides facing each other to the axis parallel to these sides is defined as D4, determining whether or not to integrate these two objects responding to a comparison between a value of (D1×D4)/(D2×D3) and a threshold, and performing a process of integrating said two objects in terms of the x axis direction and the y axis direction, respectively, in a case of integrating the objects.

The 35th mode of the present invention, in the above-mentioned mode, is characterized in that said text region generation process or said chart region generation process calculates the visual impression distance in terms of all of combinations of the minimum bounding rectangles of arbitrary two objects being included in one sheet of slide, and defines an average value thereof as said threshold.

The 36th mode of the present invention, in the above-mentioned mode, is characterized in that the program causing the information processing apparatus to execute: a region information conversion process of converting a query associated with a layout of the region of the electronic document and the document image into the region information, said query inputted by a user; and a similarity calculation process of comparing the region information of the electronic document and the document image with the region information converted by said region information conversion process, and calculating a similarity, wherein the document having a layout resembling the layout of the region of the document inputted by the user is retrieved.

The 37th mode of the present invention, in the above-mentioned mode, is characterized in that said similarity calculation process calculates the similarity by comparing a gravity coordinate value expressive of a position of the region, an area expressive of a size of the region, and an aspect ratio expressive of a shape of the region for each region class of the text region and the chart region.

The 38th mode of the present invention, in the above-mentioned mode, is characterized in that said similarity calculation process employs a cosine value of an angle subtended by feature vectors of two regions comprised of an x coordinate of the gravity, a y coordinate of the gravity, the area, and the aspect ratio when calculating the similarity.

The 39th mode of the present invention, in the above-mentioned mode, is characterized in that the program causing the information processing apparatus to execute a keyword retrieval process of retrieving the document including an inputted keyword: wherein said similarity calculation process calculates the similarity only for the document retrieved by said keyword retrieval process; and wherein the document including the keyword inputted by the user and yet having a layout resembling the layout of the region of the document inputted by the user is retrieved.

As mentioned above, the effect of the present invention resides in that the document as well having a complicated and yet multifarious layout, for example, the documentation for presentation can be appropriately region-segmented into the text region and the chart region.

The reason is that the present invention generates the text region and the chart region by extracting the objects that become configuration elements of the document, classifying these objects into the objects forming the text region and the objects forming the chart region, and further integrating the objects by determining whether or not to integrate the objects from a shape of the blank region existing between the classified objects.

Above, although the present invention has been particularly described with reference to the preferred embodiments and modes thereof, it should be readily apparent to those of ordinary skill in the art that the present invention is not always limited to the above-mentioned embodiment and modes, and changes and modifications in the form and details may be made without departing from the sprit and scope of the invention.

This application is based upon and claims the benefit of priority from Japanese patent application No. 2007-329475, filed on Dec. 21, 2007, the disclosure of which is incorporated herein in its entirety by reference.

### [How the Invention is Capable of Industrial Exploitation]

The present invention is applicable to applications such as the information extraction apparatus for extracting only the text region, or only the chart region from the electronic document or the document image, the information processing apparatus for precisely and efficiently performing the process responding to the extracted region in addition hereto, and further, the program for causing the computer to realize them.

Further, the present invention is also applicable to an application such as the information retrieval apparatus for retrieving the document based upon the layout of the text region and the chart region from a database.

1. An information processing system, comprising an object classification unit that, out of objects forming a document extracted from an electronic document or a document image, calculates an area histogram of the object including a text, classifying the object having an area that is larger than the area of the object having a mode of said area histogram, out of said objects including the text, as an objects forming a text region, and classifies the object having an area that is smaller than the area of said mode as an objects forming a chart region.

2. (canceled)

3. An information processing system according to claim 1, wherein said object classification unit calculates the area histogram of the object including the text, classifies the object having an area larger than the area that becomes a mode as an object forming the text region, and classifies the object having an area smaller than the mode and the object not including the text as an object forming the chart region, respectively.

4. An information processing system according to claim 1, wherein said object classification unit calculates the area histogram of the objects including the text, classifies the object having an area that is larger than the area that becomes a mode and yet is larger than the area in which a frequency has re-risen as an object forming the text region, and classifies the object not classified as an object forming the text region, out of said objects including the text, and the object not including the text as an object forming the chart region, respectively.

5. An information processing system according to one of claim 1, comprising an object extraction unit that extracts the objects forming the document from the electronic document or the document image.

6. An information processing system according to one of claim 1, comprising:
a text region generation unit that integrates the objects forming the text region based upon a visual impression distance, being a distance between the objects taking human being's visual impression into consideration, and generates the text region;
a chart region generation unit for integrates the objects forming the chart region based upon said visual impression distance, and generates the chart region; and
a region information generation unit for generates and outputs information expressive of the text region and the chart region.

7. An information processing system according to claim 6, wherein said text region generation unit or said chart region generation unit integrates the objects and to generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis or the y axis, and a length of an overlapping portion at the time of projecting the sides facing each other to the axis parallel to these sides is defined as D2, calculating D1/D2 as the visual impression distance, determining whether or not to integrate these two objects responding to a comparison between a value of the visual impression distance D1/D2 and a threshold, and performing a process of integrating said two objects in terms of the x axis direction and the y axis direction, respectively, in a case of integrating the objects.

8. An information processing system according to claim 6, wherein said text region generation unit or said chart region generation unit integrates the objects and generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis and the y axis, a length of an overlapping portion at the time of projecting the sides facing each other to the axis parallel to these sides is defined as D2, a sum of lengths of sides perpendicular to the sides facing each other of two objects is defined as D3, and an entire length at the time of projecting the sides facing each other to the axis parallel to these sides is defined as D4, determining whether or not to integrate these two objects responding to a comparison between a value of (D1×D4)/(D2×D3) and a threshold, and performing a process of integrating said two objects in terms of the x axis direction and the y axis direction, respectively, in a case of integrating the objects.

9. An information processing system according to claim 6, wherein said text region generation unit or said chart region generation unit calculates the visual impression distance in terms of all of combinations of the minimum bounding rectangles of arbitrary two objects being included in one sheet of slide, and to define an average value thereof as said threshold.

10. An information processing system according to one of claim 1, further comprising:
a region information storage that stores the region information of the electronic document and the document image;
a region information converter that converts a query associated with a layout of the region of the electronic document and the document image into the region information, said query inputted by a user; and
a similarity calculator for compares the region information stored by said region information storage with the region information converted by said region information converter, and calculates a similarity, wherein the document having a layout resembling the layout of the document inputted by the user is retrieved.

11. An information processing system according to claim 10, wherein said similarity calculator calculates the similarity by comparing a gravity coordinate value expressive of a position of the region, an area expressive of a size of the region, and an aspect ratio expressive of a shape of the region for each region class of the text region and the chart region.

12. An information processing system according to claim 11, wherein said similarity calculator employs a cosine value of an angle subtended by feature vectors of two regions comprised of an x coordinate of the gravity, a y coordinate of the gravity, the area, and the aspect ratio when calculating the similarity.

13. An information processing system according to claim 10, further comprising a keyword retrieval unit that retrieves the document including an inputted keyword:
wherein said similarity calculator calculates the similarity only for the document retrieved by said keyword retrieval unit; and
wherein the document including the keyword inputted by the user and yet having a layout resembling the layout of the document inputted by the user is retrieved.

14. An information processing method, comprising an object classification process of classifying out of objects forming a document extracted from an electronic document or a document image, calculating an area histogram of the object including a text, classifying the object having an area that is larger than the area of the object having a mode of said area histogram, out of said objects including the text, as an object forming a text region, and classifying the object having an area that is smaller than the area of said mode as an object forming a chart region.

15. (canceled)

16. An information processing method according to claim 14, wherein said object classification process calculates the area histogram of the object including the text, classifies the object having an area larger than the area that becomes a mode as an object forming the text region, and classifies the object having an area smaller than the mode and the object not including the text into as an object forming the chart region, respectively.

17. An information processing method according to claim 14, wherein said object classification process calculates the area histogram of the object including the text, classifies the object having an area that is larger than the area that becomes a mode, and yet is larger than the area in which a frequency has re-risen as an object forming the text region, and classifies the object not classified as an object forming the text region, out of said objects including the text, and the object not including the text as an object forming the chart region, respectively.

18. An information processing method according to claim 14, comprising an object extraction process of extracting the objects forming the document from the electronic document or the document image.

19. An information processing method according to claim 14, comprising:
a text region generation process of integrating the objects forming the text region based upon a visual impression distance, being a distance between the objects taking human being's visual impression into consideration, and generating the text region;
a chart region generation process of integrating the objects forming the chart region based upon said visual impression distance, and generating the chart region; and
a region information generation process of generating and outputting information expressive of the text region and the chart region.

20. An information processing method according to claim 19, wherein said text region generation process or said chart region generation process integrates the objects and generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis or the y axis, and a length of an overlapping portion at the time of projecting the sides facing each other to the axis parallel to these sides is defined as D2, calculating D1/D2 as the visual impression distance, determining whether or not to integrate these two objects responding to a comparison between a value of the visual impression distance D1/D2 and a threshold, and performing a process of integrating said two objects in terms of the x axis direction and the y axis direction, respectively, in a case of integrating the objects.

21. An information processing method according to claim 19, wherein said text region generation process or said chart region generation process integrates the objects and generates the region by, in a case that minimum bounding rectangles comprised of sides parallel to an x axis and a y axis of the object forming the region, respectively, overlap each other, or minimum bounding rectangles do not overlap each other, when a distance between the sides facing each other of respective minimum bounding rectangles is defined as D1 in terms of the objects having an overlap at the time of projecting two objects to the x axis or the y axis, a length of an overlapping portion at the time of projecting the sides facing each other to the axis parallel to these sides is defined as D2, a sum of lengths of sides perpendicular to the sides facing each other of two objects is defined as D3, and an entire length at the time of projecting the sides facing each other to the axis parallel to these sides is defined as D4, determining whether or not to integrate these two objects responding to a comparison between a value of (D1×D4)/(D2×D3) and a threshold, and performing a process of integrating said two objects in terms of the x axis direction and the y axis direction, respectively, in a case of integrating the objects.

22. An information processing method according to claim 19, wherein said text region generation process or said chart region generation process calculates the visual impression distance in terms of all of combinations of the minimum bounding rectangles of arbitrary two objects being included in one sheet of slide, and defines an average value thereof as said threshold.

23. An information processing method according to claim 14, further comprising:
a region information conversion process of converting a query associated with a layout of the region of the electronic document and the document image into the region information, said query inputted by a user; and
a similarity calculation process of comparing the region information of the electronic document and the document image with the region information converted by said region information conversion process, and calculating a similarity, wherein the document having a layout resembling the layout of the region of the document inputted by the user is retrieved.

24. An information processing method according to claim 23, wherein said similarity calculation process calculates the similarity by comparing a gravity coordinate value expressive of a position of the region, an area expressive of a size of the region, and an aspect ratio expressive of a shape of the region for each region class of the text region and the chart region.

25. An information processing method according to claim 23, wherein said similarity calculation process employs a cosine value of an angle subtended by feature vectors of two regions comprised of an x coordinate of the gravity, a y coordinate of the gravity, the area, and the aspect ratio when calculating the similarity.

26. An information processing method according to claim 23, further comprising a keyword retrieval process of retrieving the document including an inputted keyword:
wherein said similarity calculation process calculates the similarity only for the document retrieved by said keyword retrieval process; and
wherein the document including the keyword inputted by the user and yet having a layout resembling the layout of the region of the document inputted by the user is retrieved.

27. A computer readable storage medium storing a program for causing an information processing apparatus to execute an object classification process of, out of objects forming a document extracted from an electronic document or a document image, calculating an area histogram of the object including a text, classifying the object having an area that is larger than the area of the object having a mode of said area histogram, out of said objects including the text, as an objects forming a text region, and classifying the object having an area that is smaller than the area of said mode as an objects forming a chart region.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)
